(19) United States
(12) Patent Application Publication
(10) Pub. No.: US 2026/0161861 A1
(43) Pub. Date: Jun. 11, 2026

(54) THERMAL MODELING METHOD OF MAGNETIC COUPLER IN INDUCTIVE POWER TRANSFER APPLICATIONS

(71) Applicant: City University of Hong Kong, Kowloon (HK)

(72) Inventors: Weisheng GUO, Kowloon (HK); Chaoqiang JIANG, Kowloon (HK); Yibo WANG, Kowloon (HK); Xiaosheng WANG, Kowloon (HK)

(21) Appl. No.: 19/384,059

(22) Filed: Nov. 10, 2025

Related U.S. Application Data
(60) Provisional application No. 63/730,440, filed on Dec. 10, 2024.

(51) Int. Cl. G06F 30/28; G06F 30/23; G06F 111/10; G06F 119/08

(52) U.S. Cl. CPC G06F 30/28; G06F 30/23; G06F 2111/10; G06F 2119/08

(57) ABSTRACT

A computer-implemented thermal modeling method for a magnetic coupler used in an inductive power transfer system. The method includes: providing a core model of a magnetic core of the magnetic coupler; dividing the core model into a plurality of core blocks to obtain a divided core; providing a coil model of a coil of the magnetic coupler; homogenizing the coil model to obtain a homogenized coil; and setting an equivalent contact thermal resistance at an interface between the divided core and the homogenized coil. Experimental results show that the numerical model can simulate the dynamic temperature changes of the magnetic coupler with an error of 4.2% after calibration and 6.0% without calibration.

### FIELD OF INVENTION

This invention relates to inductive power transfer (IPT) systems, and in particular to thermal modeling methods for magnetic couplers.

### BACKGROUND OF INVENTION

Inductive power transfer (IPT) enables energy transfer through a time-varying electromagnetic field, eliminating galvanic connections to charging devices [1], [2]. Due to better convenience and higher flexibility, IPT technology has been widely applied in various fields, ranging from low-power electronic devices to high-power transportation systems [3], [4].

Temperature is a vital operation parameter affecting the stability and reliability of the IPT system. The increase in power density, combined with a compact structure, poses a strong thermal challenge to the reliable operation of the IPT system [5]. For widely used Mn—Zn ferrites in the magnetic coupler, their performance is known to be highly sensitive to temperature [6]. Once the operating temperature of the ferrite core exceeds a critical temperature, the core loss will increase with temperature. Without timely intervention, the core in the magnetic coupler will experience catastrophic thermal runaway [7]. Therefore, for safe and reliable operation, more attention needs to be paid to evaluating the IPT system's thermal performance, with a particular focus on the hotspots of the core in the magnetic coupler.

According to the existing literature, two types of thermal models have been used to study the thermal aspects of the magnetic coupler, namely, thermal network model (TNM) and the numerical model. TNMs, due to their low computational complexity, are frequently used in the thermal analysis of the magnetic coupler. In [8], a simplified 1-D TNM was built to estimate the hotspot temperatures in the coil and the ferrite core. The estimation results allow for a quick assessment of the thermal feasibility of the coil design. In [9], a two-stage Cauer TNM composed of the magnetic coupler and the cooling structure was established to derive the peak temperature and the maximum allowable loss, facilitating cooling structure design under load fluctuations. However, the above proposed thermal network models oversimplify the heat transfer in the magnetic coupler, which will introduce a large estimation error. To further improve the estimation accuracy, 2-D TNMs incorporating more details have been developed. In [10], a 2-D TNM was constructed to predict the average temperature of the heating components in the water-cooled vehicle assembly. Based on the structure symmetry, 2-D TNMs featuring both accuracy and simplicity were built to investigate the coil's thermal properties [11], [12]. Different magnetic couplers exhibit distinct heat transfer paths, resulting in varying network structures. This necessitates an in-depth understanding of the heat transfer paths within the magnetic coupler. Additionally, the 2-D TNM can only estimate the temperatures of very limited nodes. For systems with uneven heat source distribution, such as double-D coil based magnetic coupler, a 3-D TNM with a large number of nodes is required to reflect the non-uniform temperature distribution. However, the thermal network model construction process may be complicated.

With the rapid improvement of computer performance, numerical simulation has been widely adopted for more accurate thermal evaluation of the magnetic coupler. Typical numerical analysis methods include finite-element method (FEM), finite-volume method (FVM), and finite-difference method (FDM) [13]. In [10] and [14], FEM-based numerical models were established to investigate the thermal performance of the magnetic coupler. In [15], a pseudo-3D numerical model based on FDM was developed to enable rapid and accurate thermal evaluation. However, the above numerical models do not consider the impact of temperature on the power losses. With the aid of commercial software, it is very convenient to implement electromagnetic-thermal coupling. In [16], a magnetic and thermal coupled field analysis was conducted to investigate the impact of operating frequency on the system's heat generation. In [17], the electromagnetic-thermal simulation was used for steady-state thermal analysis and optimization of the magnetic coupler. Besides, S. Niu et al. performed a comprehensive two-way coupled simulation to investigate thermal risks under misalignment, foreign object intrusion, and coil short-circuit conditions in a wireless electric vehicle charging system [18], [19].

Although numerical simulation has the potential to provide more accurate temperature results, the existing numerical models still have limitations in certain detailed aspects, such as failing to account for the thermal conductivity anisotropy of the coil [20], and using the surface average convection coefficient to simplify the simulation. The errors introduced by these simplifications in the simulation setup are not evaluated.

### REFERENCES

Each of the following references (and associated appendices and/or supplements) is expressly incorporated herein by reference in its entirety:
[1] G. A. Covic and J. T. Boys, “Inductive power transfer,” Proc. IEEE, vol. 101, no. 6, pp. 1276-1289 June 2013.
[2] Z. Zhang, H. Pang, A. Georgiadis and C. Cecati, “Wireless power transfer—An overview,” IEEE Trans. Ind. Electron., vol. 66, no. 2, pp. 1044-158 February 2019.
[3] H. Feng, R. Tavakoli, O. C. Onar and Z. Pantic, “Advances in high-power wireless charging systems: Overview and design considerations,” IEEE Trans. Transp. Electrific., vol. 6, no. 3, pp. 886-919, September 2020.
[4] C. Jiang, K. T. Chau, C. Liu, and C. H. T. Lee, “An overview of resonant circuits for wireless power transfer,” Energies, vol. 10, no. 7, 2017, Art. no. 894.
[5] S. Jayalath and A. Khan, “Design, challenges, and trends of inductive power transfer couplers for electric vehicles: A review,” IEEE J. Emerg. Sel. Top. Power Electron., vol. 9, no. 5, pp. 6196-6218 October 2021.
[6] J. J. Suh, B. M. Song and Y. H. Han, “Temperature dependence of power loss of Mn—Zn ferrites at high frequency,” IEEE Trans. Magn., vol. 36, no. 5, pp. 3402-344 September 2000.
[7] F. Farahmand, F. P. Dawson and J. D. Lavers, “Critical temperature for thermal runaway in a magnetic material,” IEEE Trans. Magn., vol. 44, no. 11, pp. 4513-4516 November 2008.
[8] R. Bosshard and J. W. Kolar, “Multi-objective optimization of 50 kW/85 kHz IPT System for public transport,” IEEE J. Emerg. Sel. Top. Power Electron., vol. 4, no. 4, pp. 1370-1382 December 2016.
[9] J. I. Itoh, K. Mizoguchi, L. H. Nam and K. Kusaka, “Design method of cooling structure considering load fluctuation of high-power wireless power transfer system,” in Proc. IEEE 4th Int. Future Energy Electron. Conf., 2019, pp. 1-6.
[10] B. Zhang et al., “Multi-objective Thermal optimization based on improved analytical thermal models of a 30-kW IPT system for EVs,” IEEE Trans. Transp. Electrific., vol. 9, no. 1, pp. 1910-1926 March 2023.
[11] X. Du and D. Dujic, “Modeling and Design optimization of loosely coupled PCB spiral coils in inductive power transfer systems,” IEEE Trans. Power Electron., vol. 38, no. 11, pp. 13430-13442, November 2023.
[12] D. Wang, J. Wei, H. Feng and L. Ran, “A thermal black-box theory for scaling design of planar magnetic coils in wireless charging systems,” IEEE Trans. Power Electron., vol. 39, no. 7, pp. 8973-8984 July 2024.
[13] J. N. Reddy, N. K. Anand, and P. Roy, Finite Element and Finite Volume Methods for Heat Transfer and Fluid Dynamics. New York, NY 10006, USA: Cambridge University Press, 2022.
[14] X. Zhang et al., “Ferrite pads gap thermal-magnetic evaluation and mitigation for 11.1 kW wireless power transfer,” IEEE Trans. Magn., vol. 59, no. 11, pp. 1-6, November 2023.
[15] H. Yin, C. Zhu, H. Liu, J. Li, and X. Zhang, “Rapid and accurate thermal evaluation of IPT pads based on Pseudo-3D finite difference method,” IEEE Trans. Transp. Electrific., pp. 1-1, January 2024.
[16] M. Tiemann, M. Saifo, M. Clemens and B. Schmuelling, “Magnetic and thermal coupled field analysis of wireless charging systems for electric vehicles,” IEEE Trans. Magn., vol. 55, no. 6, pp. 1-4, June 2019.
[17] J. Ma, Z. Li, Y. Liu, M. Ban and W. Song, “Thermal analysis and optimization of the magnetic coupler for wireless charging system,” IEEE Trans. Power Electron., vol. 38, no. 12, pp. 16269-16280, December 2023.
[18] S. Niu, Q. Zhao, S. Niu, and L. Jian, “A Comprehensive Investigation of Thermal Risks in Wireless EV Chargers Considering Spatial Misalignment from A Dynamic Perspective,” IEEE J. Emerg. Sel. Top. Ind. Electron., pp. 1-11, January 2024.
[19] S. Niu, H. Yu, S. Niu, and L. Jian, “Power loss analysis and thermal assessment on wireless electric vehicle charging technology: The over-temperature risk of ground assembly needs attention,” Appl. Energy, vol. 275, October 2020, Art. no. 115344.
[20] Z. Li et al., “Analytical calculation and experimental validation of Litz wires axial thermal conductivity,” IEEE Trans. Transp. Electrific., vol. 10, no. 1, pp. 1167-1179 March 2024.
[21] Wireless Power Transfer for Light-Duty Plug-In/Electric Vehicles and Alignment Methodology, International Standard SAE J2954, 2019.
[22] Z. Luo, S. Nie, M. Pathmanathan, W. Han and P. W. Lehn, “3-D analytical model of bipolar coils with multiple finite magnetic shields for wireless electric vehicle charging systems,” IEEE Trans. Ind. Electron., vol. 69, no. 8, pp. 8231-8242 August 2022.
[23] F. P. Incropera, A. S. Lavine, T. L. Bergman, and D. P. DeWitt, Fundamentals of Heat and Mass Transfer. Hoboken, NJ, USA: Wiley, 2007.
[24] E. Aydin, H. Barua, A. Aktas, M. Mohammad, O. C. Onar and B. Ozpineci, “Thermal Analysis of a 100 kW Polyphase Wireless Power Transfer System,” 2024 IEEE Applied Power Electronics Conference and Exposition (APEC), Long Beach, CA, USA, 2024, pp. 1927-1931.
[25] Z. Wang, C. L. Bak, H. Wang, H. Sørensen and F. F. da Silva, “Multiphysics digital model of the high frequency transformer for power electronics application considering electro-thermal interactions,” IEEE Trans. Power Electron., vol. 38, no. 11, pp. 14345-14359, November 2023.
[26] Icepak Scripting Guide Release 2023R2, ANSYS Inc., Canonsburg, PA, USA, July 2023.
[27] Maxwell Scripting Guide Release 2023R2, ANSYS Inc., Canonsburg, PA, USA, July 2023.
[28] Thermal properties of polycarbonate. [Online]. Available: https://en.wikipedia.org/wiki/Polycarbonate?useskin=vector#cite note-4.
[29] Icepak Help Release 2023R2, ANSYS Inc., Canonsburg, PA, USA, July 2023.
[30] F. Chauvicourt, P. Romanazzi, D. Howey, A. Dziechciarz, C. Martis and C. T. Faria, “Review of multidisciplinary homogenization techniques applied to electric machines,” in Proc. 11th Int. Conf. Ecological Veh. Renewable Energies, 2016, pp. 1-9.
[31] G. Salinas López, A. D. Expósito, J. Muñoz-Antón, J. Á. O. Ramírez and R. P. López, “Fast and accurate thermal modeling of magnetic components by FEA-based homogenization,” IEEE Trans. Power Electron., vol. 35, no. 2, pp. 1830-1844 February 2020.
[32] Property tables and charts [SI units]. [Online]. Available:
   https://cecs.wright.edu/people/faculty/sthomas/htappendix01.pdf.
[33] Specific heat capacity of silk. [Online]. Available: https://www.engineeringtoolbox.com/specific-heat-solids-d_154.html.
[34] Chemical nature of silk and properties of silk. [Online]. Available: https://www.jagiroadcollegelive.co.in/attendence/classnotes/files/1587912255.pdf.
[35] H. Nakamura, “Error analysis of surface temperature measurement by thermocouple,” Trans. JSME., vol. 84, no. 867, pp. 18-00216, November 2018.
[36] B. Chen, B. Starman, M. Halilovič, L. A. Berglund, and S. Coppieters, “Finite Element Model Updating for Material Model Calibration: A Review and Guide to Practice,” Archives of Computational Methods in Engineering, pp. 1-78, 2024.

### SUMMARY OF INVENTION

Accordingly, the present invention in one aspect provides a computer-implemented thermal modeling method for a magnetic coupler used in an inductive power transfer system. The method includes the steps of a) providing a core model of a magnetic core of the magnetic coupler; b) dividing the core model into a plurality of core blocks to obtain a divided core; c) providing a coil model of a coil of the magnetic coupler; d) homogenizing the coil model to obtain a homogenized coil; and e) setting an equivalent contact thermal resistance at an interface between the divided core and the homogenized coil.

In some embodiments, Step a) further includes the steps of: f) simulating magnetic flux density in the magnetic core; and g) converting the amplitude of the magnetic flux density into temperature-dependent losses.

In some embodiments, Step b) further includes the steps of h) constructing a geometric model of the magnetic core; i) geometrically segmenting the geometric model into the plurality of core blocks; and j) mapping the temperature-dependent losses to respective ones of the plurality of core blocks.

In some embodiments, in Step g) the converting into the temperature-dependent losses is by region.

In some embodiments, the coil model is homogenized at a first coil level and a second coil level.

In some embodiments, the first coil level is a Litz wire level.

In some embodiments, the second coil level is a coupler coil level.

In some embodiments, Step d) further contains the step of dividing the coil model into a plurality of coil blocks.

In some embodiments, Step b) further includes the steps of determining the minimum number of core divisions and applying a core loss to each of the core blocks.

In some embodiments, the method further includes the step of determining the value of contact thermal resistance by DC heating experiments.

According to another aspect of the invention, there is provided a non-transitory computer-readable medium, having stored thereon program instructions that, upon execution by a computing device, cause the computing device to perform the method as described above or any of its variants.

According to a further aspect of the invention, there is provided a computing system which includes one or more processors; and memory containing instructions that, when executed by the one or more processors, cause the computing system to perform the method as described above or any of its variants.

One can see that exemplary embodiments of the invention therefore provide a comprehensive transient thermal analysis for the IPT double-D magnetic coupler. An automated interactive tool has been developed to improve the efficiency of model construction and transient thermal analysis. The CFD (computational fluid dynamics)-based numerical model fully takes into account critical factors that impact accuracy during the modeling process, such as the thermal anisotropy of the coil, contact thermal resistance at the core-coil interface, radiation effects, etc.

### BRIEF DESCRIPTION OF FIGURES

The foregoing and further features of the present invention will be apparent from the following description of embodiments which are provided by way of example only in connection with the accompanying figure(s), of which:

FIG. 1a shows the overall structure of a IPT double-D magnetic coupler for electrical vehicles.

FIG. 1b illustrates the detailed geometry of a double-D coil in the IPT double-D magnetic coupler of FIG. 1a.

FIG. 2 illustrates the magnetic flux density distribution in the magnetic core of the magnetic coupler in FIG. 1.

FIG. 3 illustrates the magnetic flux density distribution per ampere current along the line segment AB in FIG. 2 under different current excitations.

FIG. 4 illustrates the magnetic flux density distribution along the line segment AB in FIG. 2 under different relative permeabilities.

FIG. 5 shows the framework of an automated interactive tool between Maxwell and Icepak via the Python custom coding.

FIG. 6 illustrates the schematic of the magnetic coupler of FIG. 1 modeled in Icepak for CFD simulation. The zero-equation model is utilized to tackle turbulent flow problem, while the discrete ordinates radiation model is employed to solve the radiative transfer equation. The time step of the transient simulation is set to 100 seconds.

FIG. 7a shows the geometric segmentation of the magnetic core of the magnetic coupler of FIG. 1 and power loss mapping.

FIG. 7b shows approximation of core loss density along the line segment AB in FIG. 2.

FIG. 8a shows the core temperature distribution along the line segment AB in FIG. 2 under different segmentation schemes.

FIG. 8b shows the error distribution of the core temperature along the line segment AB in FIG. 2 under different segmentation schemes.

FIG. 9 shows the internal structure of Litz Wire and homogenized model.

FIG. 10 is a photo showing the experimental setup prototype of the IPT system of FIG. 1 with thermal imaging and hotspot measurement.

FIG. 11 shows typical current circulating schematic of the IPT system in FIG. 10 with a H-bridge SiC inverter in the primary and a full-bridge SiC passive rectifier in the secondary.

FIG. 12 shows measured voltage and current waveforms of IPT system in FIG. 10 under U_{DC}=310 V.

FIG. 13a shows the thermal image of the magnetic coupler under DC input current I_{DC}=21.7 A.

FIG. 13b shows the thermal image of the magnetic coupler under DC input current I_{DC}=30.5 A.

FIG. 14a shows the comparison of numerical simulations and experimental measurements under I_{DC}=21.7 A; boundary conditions of numerical model: the power loss of the coil and the ambient temperature are set to 15.14 W and 21.5° C., respectively.

FIG. 14b shows the comparison of numerical simulations and experimental measurements under I_{DC}=30.5 A, boundary conditions: the power loss of the coil and the ambient temperature are set to 30.9 W and 20.7° C., respectively.

FIG. 15 shows a thermal image with thermal spots detection when U_{DC}=310 V.

FIG. 16a shows steady-state temperature distribution contour map of the magnetic coupler when U_{DC}=310 V.

FIG. 16b shows the comparison of numerical simulations and experimental measurements when U_{DC}=310 V.

FIG. 17 shows a thermal image with thermal spots detection when U_{DC}=200 V.

FIG. 18 shows comparison of numerical simulation and experimental measurement when U_{DC}=200 V.

FIG. 19 shows a thermal image with thermal spots detection when U_{DC}=185 V with misalignment (X=90 mm, Y=60 mm)

FIG. 20 shows a comparison of numerical simulation and experimental measurement when U_{DC}=185 V with misalignment (X=90 mm, Y=60 mm).

FIG. 21 is a table showing the performance comparison between a preferred embodiment of the invention (labelled as “our work”) and other conventional art.

FIG. 22 shows the structure of an exemplary information handling apparatus that can be used to implement the methods as described above.

### DETAILED DESCRIPTION

Exemplary embodiments of the invention provide an accurate transient thermal analysis for the IPT double-D magnetic coupler, covering power loss measurements for the coil and the magnetic core. An automated interactive tool is developed to achieve fast thermal modeling and transient analysis. To enhance the simulation accuracy and efficiency of the numerical model, geometric segmentation modeling and homogenization modeling are employed for the magnetic core and the coil, respectively. Finally, experimental measurements, including tests at power levels up to 5.2 kW and under coil misalignment conditions, are conducted to validate the numerical model. The results demonstrate that under transient conditions, the numerical model achieves a maximum error of only 4.2% with calibration and 6.0% without calibration.

Exemplary embodiments of this invention focus on accurate transient thermal analysis for the ferrite-based IPT coupler using double-D coil. Some major characteristics are as follows:
1) An automated interactive tool between Maxwell and Icepak via Python custom coding is developed. This tool can significantly accelerate numerical model generation and transient thermal analysis for the magnetic coupler.
2) A CFD-based numerical model for the magnetic coupler is built. The geometric segmentation modeling and homogenization modeling are employed for the core and the coil, respectively. The accuracy of the numerical model has been verified through a series of experiments.

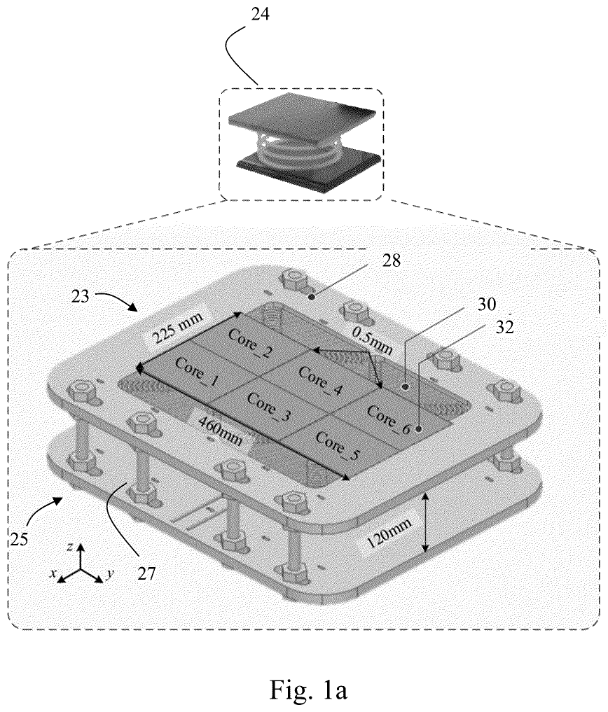

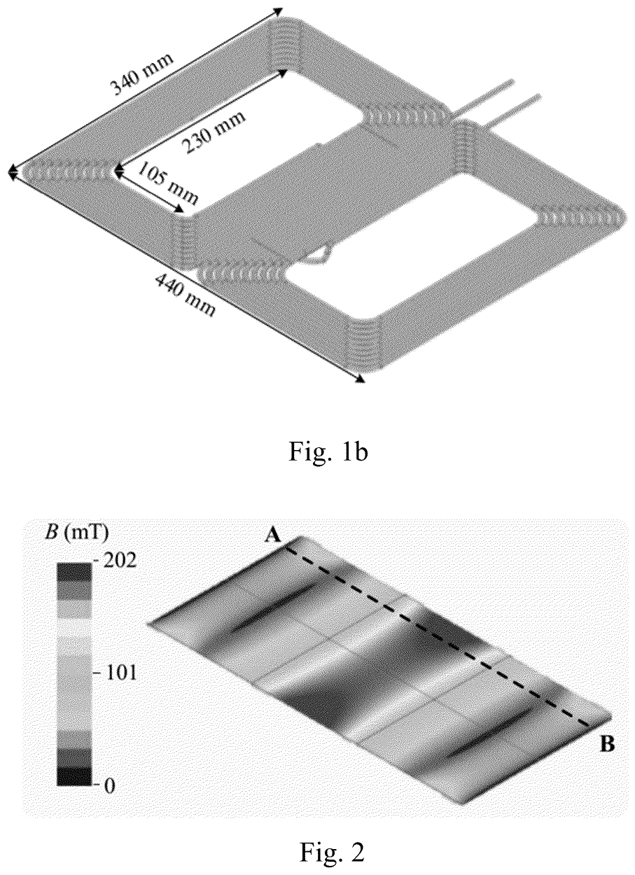

In a first embodiment of the invention, as shown in FIG. 1a, there is provided a IPT magnetic coupler 24 utilizing double-D coils (e.g., a primary coil 30). The IPT magnetic coupler 24 includes two layers that are substantially identical to each other. For the purpose of easy reference, the upper layer in FIG. 1a is called the primary layer 23, while the bottom layer is called the secondary layer 25. The primary layer 23 and the secondary layer 25, respectively, contain a primary pad 32 and a secondary pad (not shown in FIG. 1a). The two pads are completely symmetrical in design, and the air gap between the two pads in one exemplary implementation is 120 mm, which can be classified as the Z1 class [21]. In the exemplary implementation, each pad includes 6 DMR95 Mn—Zn ferrite plates of equal size, measuring 153 mm×112.5 mm×4 mm. In FIG. 1a, only the ferrite plates of the primary pad 32 are shown, which are labeled as Core_1 to Core_6. In the y-axis direction, there is a 0.5 mm core air gap between every two adjacent ferrite plates. This air gap is controlled through 0.5 mm-thick Nomex paper. Along the x-axis direction, any two adjacent ferrite plates are in direct contact with each other.

The two magnetic cores are directly placed on their respective double-D coils, for example, the primary pad 32 is placed on the primary coil 30. In the exemplary implementation, the external dimensions of a coil are 440 mm×340 mm, and the internal dimensions are 230 mm×105 mm, as shown in FIG. 1b. The double-D coil is tightly wound with 0.1 mm×1300 strands Litz wire and has 10 turns. As part of the design, certain parameter selections, such as the core or coil dimensions, do not affect the subsequent thermal analysis.

For each of the primary layer 23 and the secondary layer 25, there is a polycarbonate enclosure 28, inside which the respective magnetic core and the coil are placed. The two polycarbonate enclosures 28 are interconnected with each other by a plurality of screws 27.

Due to the structural characteristics of the double-D coil, the magnetic flux density inside the magnetic core is highly non-uniformly distributed along the y-axis direction, as shown in FIG. 2. Additionally, the ferrite core exhibits typical nonlinear characteristics. For example, the relative permeability will undergo a significant change with the variation of magnetic field strength and temperature. These factors bring great inconvenience to magnetic field analysis. Fortunately, due to the effect of the air gap, the magnetic coupler can be approximated as a magnetically linear system, meeting both superposition [22] and homogeneity.

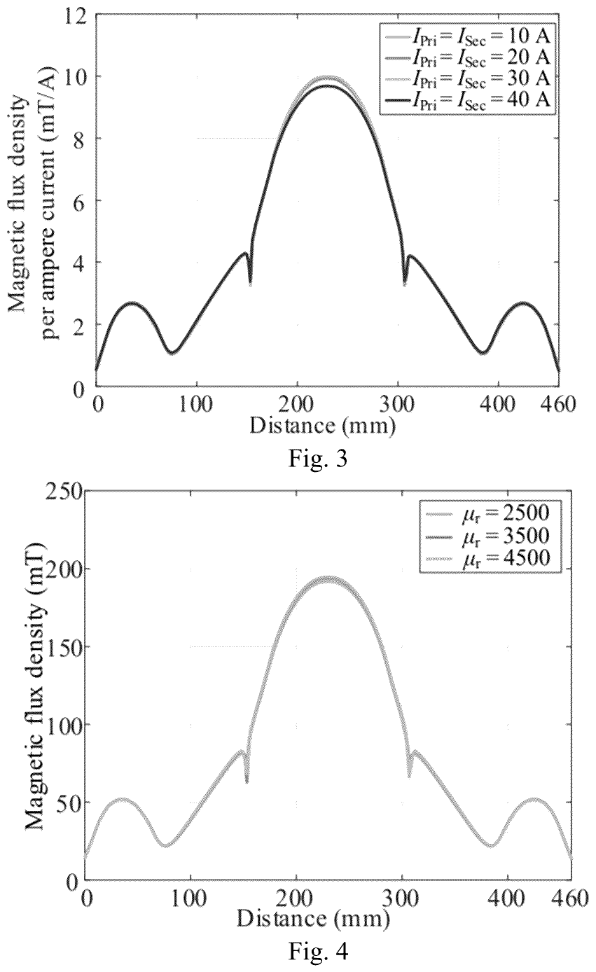

FIG. 3 shows the magnetic flux density distribution per ampere current along the line segment AB under different current excitations, where the magnetic flux density distribution per ampere current is hardly affected by magnetic field strength. I_{Pri} and I_{Sec} represent the root mean square (RMS) values of the primary current and the secondary current, respectively. The magnetic flux density dip at 153 mm and 306 mm is caused by the presence of 0.5 mm air gaps between the magnetic cores. The magnetic flux density distributions per ampere current for I_{Pri}=I_{Sec}=10 A, I_{Pri}=I_{Sec}=20 A, and I_{Pri}=I_{Sec}=30 A are nearly identical, and there is a maximum deviation of 0.3 mT/A when compared to the magnetic flux density distribution per ampere current for I_{Pri}=I_{Sec}=40 A. This minor deviation is primarily attributed to the reduced relative permeability under the high-current excitation. The magnetic flux density can be considered approximately proportional to the RMS value of the current excitation.

FIG. 4 shows the magnetic flux density distribution along the line segment AB under different permeabilities, where the primary current and the secondary coil current are set to I_{Pri}=20 A and I_{Sec}=20 A, respectively. When the relative permeability changes from μᵣ=2500 to μᵣ=4500, the magnetic flux density distribution remains largely unchanged. Temperature is a significant parameter affecting the relative permeability, but its impact on the magnetic flux density distribution inside the core is negligible. In other words, the magnetic flux density distribution is basically unaffected by temperature.

For the computer-implemented thermal modeling methods according to various embodiments of the invention, the main focus is on the transient thermal behavior of conjugate natural convection heat transfer in the magnetic coupler. In solids, heat transfer is typically dominated by conduction, whereas in fluids, convection tends to be the dominant mechanism.

The heat transfer inside the solid components can be described by the heat conduction equation [23]:

$$\frac{\partial }{\partial x} ( {k}_{x} \frac{\partial T}{\partial x} ) + \frac{\partial }{\partial y} ( {k}_{y} \frac{\partial T}{\partial y} ) + \frac{\partial }{\partial z} ( {k}_{z} \frac{\partial T}{\partial z} ) + q = ρ {c}_{p} \frac{\partial T}{\partial t} \qquad ( 1 )$$

where kₓ, k_{y}, and k_{z} are the thermal conductivities in the x, y, and z dimensions, respectively, q is the rate at which energy is generated per unit volume of the medium, ρ is the density, and cₚ is the specific heat capacity. The thermal conductivity of the coil in the IPT system exhibits significant anisotropy.

The heat transfer in the airflow field can be described by mass conservation, momentum conservation, and energy conservation equations:

$$∇ \cdot V = 0 \qquad ( 2 )$$

$$\frac{\partial V}{\partial t} + V \cdot ∇ ( V ) = - \frac{1}{ρ} ∇ p + υ {∇}^{2} V + g$$

$$ρ {c}_{p} \frac{\partial T}{\partial t} + ρ {c}_{p} V \cdot ∇ T = ∇ \cdot ( k ∇ T ) + q$$

where V is the velocity vector of air, p is the pressure, u is the kinematic viscosity, g is the gravitational acceleration vector [23], [25].

In natural convection, radiative heat transfer often constitutes a non-negligible portion of the total heat transfer. If the radiative heat transfer is not considered, it will overestimate the actual temperatures in the simulation model. The amount of heat transfer due to radiation from the surface of an object to its surroundings per unit area can be expressed as:

$$\text{?} \qquad ( 3 )$$

$$\text{?} \text{indicates text missing or illegible when filed}$$

where ε is the surface emissivity, o is the Stefan-Boltzmann constant, Tₛᵤᵣ and Tₐ are the absolute temperatures (K) of the surface and ambient, respectively [23].

Equations (1)-(3) describe the highly nonlinear heat transfer mechanism in the IPT system and are used to model the heat transfer process in the simulation. In one embodiment, ANSYS Icepak is employed to discretize these heat equations based on FVM and to perform a comprehensive analysis of thermal and fluid flow behavior for the IPT system.

The IPT system has the potential to achieve full charging for electric vehicles in 30 minutes or less. In the charging process, the key components in the IPT system may not reach thermal steady-state conditions due to the short duration [24]. Transient temperature information is key to identifying thermal risks and ensuring safe operation [19]. Therefore, the analysis herein focuses on the transient thermal analysis of the IPT system.

The Ansys Electronics Desktop (AEDT) platform enables electromagnetic-thermal two-way coupling simulation, but this analysis comes at a cost: the steady-state simulation may take several hours [25]. For long time-scale transient simulation, the simulation time will be several days, which brings significant inconvenience to transient thermal analysis.

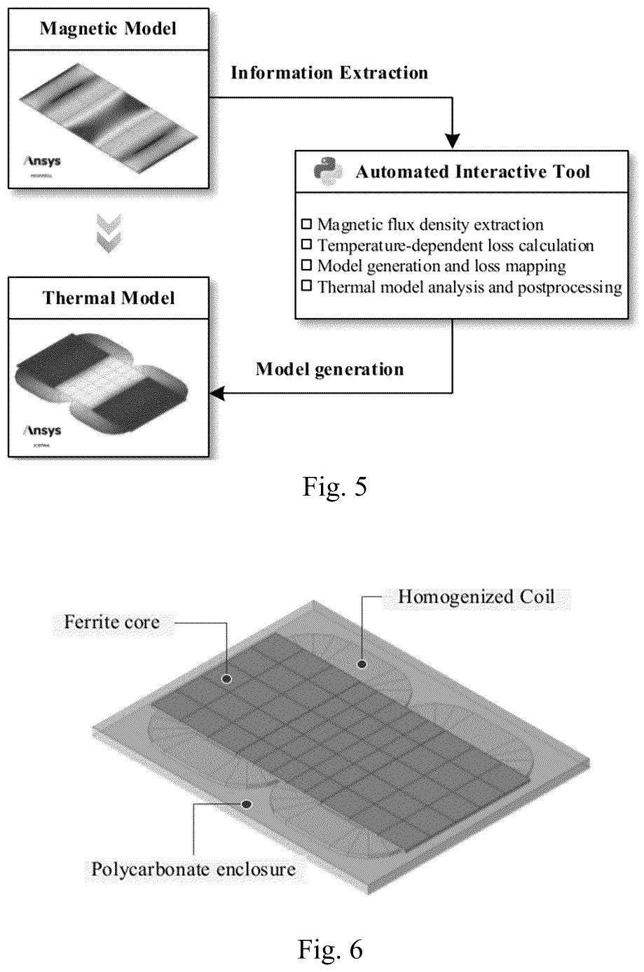

To overcome the above limitation and realize the interaction between Maxwell and Icepak, an automated interactive tool based on the Python programming language has been developed [26], [27], as shown in FIG. 5. The developed tool consists of three core components:
1) Perform Maxwell simulation using the given primary and secondary currents, and export the magnetic flux density.
2) Convert the magnetic flux density amplitude by region into temperature-dependent losses.
3) Based on the defined numbers, construct the geometric model of the objects, set the object properties, map the power losses to the corresponding blocks in Icepak, and solve the numerical model.

The tool significantly automates the modeling process and generates numerical models that can complete transient thermal analysis within a reasonable time. Furthermore, the parametric modeling functionality of this tool can also aid in model calibration and magnetic coupler optimization.

Magnetic field analysis considers both magnetic fields emitted by the primary and the secondary coils. Due to the weak thermal coupling between the primary and the secondary pads, the thermal analysis focuses solely on the primary pad. Using the developed automated interactive tool, a numerical model of the magnetic coupler has been built based on real dimensions in Icepak, as shown in FIG. 6. The material properties are listed in Table I. In this model, the original 6 large cores are divided into 55 smaller cores and the actual coil is replaced by a homogenized coil with the same volume. The homogenized coil exhibits anisotropic thermal conductivity, with different values in the transverse and longitudinal directions. Due to the continuously varying orientation, it's impossible to define the coil's thermal anisotropy using a single global Cartesian coordinate system. Therefore, the homogenized coil is divided into a series of small coil blocks, each with its own local coordinate system [29]. Additionally, to simulate natural convection accurately, the air domain needs to be set sufficiently large according to the characteristic dimensions of the primary pad.

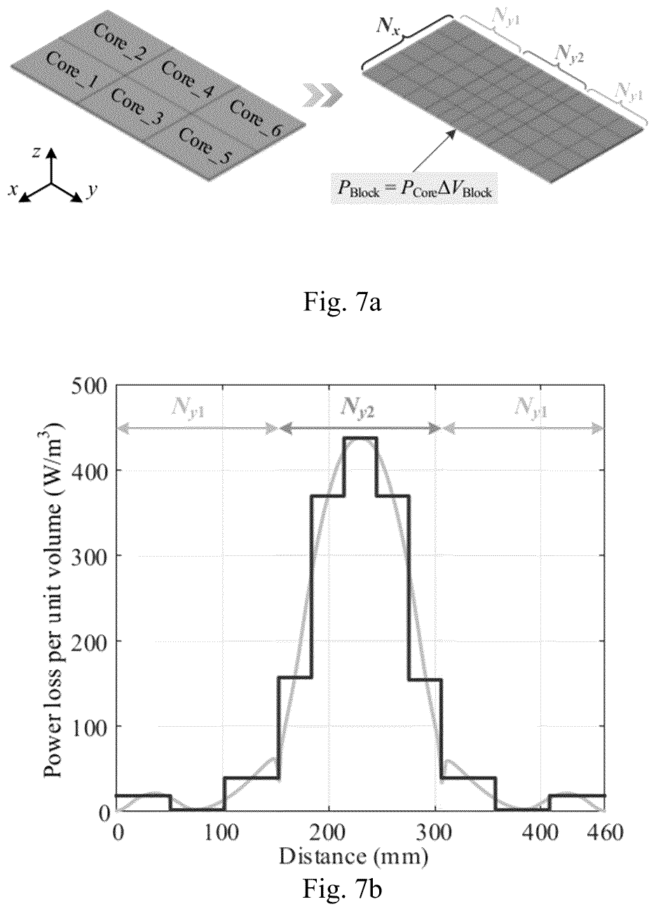

The loss within the magnetic core is highly non-uniformly distributed, particularly along the y-axis direction. To accurately simulate the thermal behavior of the magnetic core, the non-uniform core loss needs to be mapped to the corresponding position in the thermal model as input. Due to AEDT's functional limitations, the mapping function is achieved by geometrically segmenting the magnetic core into multiple small blocks and applying approximate core loss to each block, as shown in FIG. 7a. Specifically, Nₓ, N_{y1}, and N_{y2} represent the segmentation number along the x-axis direction, the segmentation number along the y-axis direction for Core_1, Core_2, Core_5, and Core_6, and the segmentation number along the y-axis direction for Core_3 and Core_4, respectively. Each core block is applied with a core loss P_{Block}=P_{Core}ΔV, where P_{Core} is the core loss density, and ΔV is the block volume. To obtain the core loss of each small block, the highly non-uniformly distributed power loss needs to be approximated based on the defined three segmentation numbers (Nₓ, N_{y1}, and N_{y2}). In this study, for each segment [d₁, d₂], the core loss density value at the midpoint dₘ=(d₁+d₂)/2 is chosen as the representative value, as shown in FIG. 7b. As the number of segments increases, the approximated core loss density becomes closer to the actual distribution.

TABLE I
MATERIAL PROPERTIES IN WPT SYSTEM

| | Ferrite | Homogenized | Polycarbonate | |
|---|---|---|---|---|
| Parameters | core | coil | enclosure [28] | Air |
| Thermal Conductivity | 5 | Longitudinal: 191 | 0.20 | 0.025 |
| (W · m⁻¹ · K⁻¹) | | Transverse: 0.22 | | |
| Specific Heat Capacity | 700 | 360 | 1250 | 1007 |
| (J · kg⁻¹ · K⁻¹) | | | | |
| Density (kg · m⁻³) | 4800 | 3562 | 1210 | 1.204 |
| Surface Emissivity | 0.85 | None | 0.85 | None |

Note:
The longitudinal thermal conductivity of the coil is much greater than the transverse thermal conductivity.

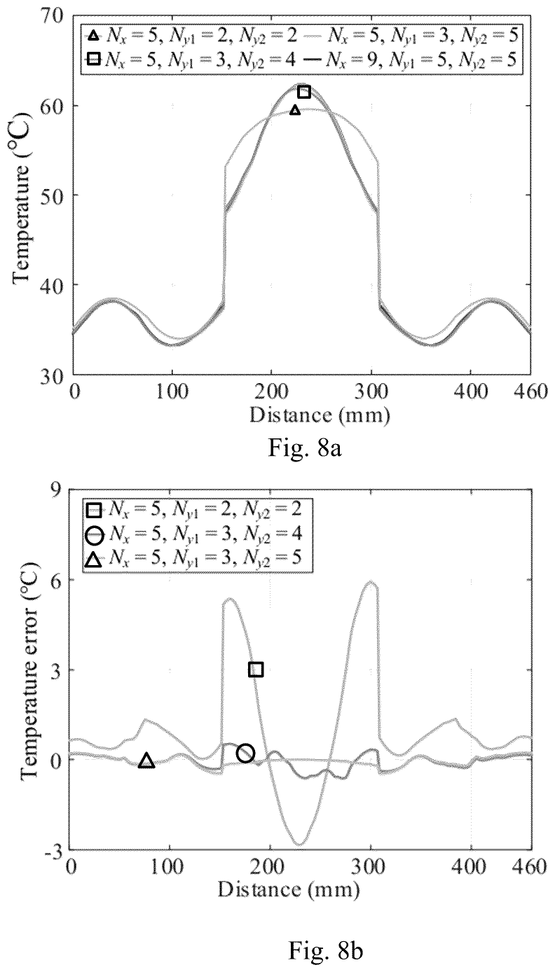

Although more refined segmentation can bring more accurate simulation results, the thermal modeling process becomes more complex, and the solution time increases. Using the automated modeling tool, the core temperature along the line segment AB for different segmentation schemes can be obtained as illustrated in FIGS. 8a-8b. The simulation results obtained with Nₓ=9, N_{y1}=5, and N_{y2}=5 are used as the reference for accuracy. FIG. 8a shows the core temperature distribution along the line segment AB under different segmentation schemes. As the segmentation number increases, the temperature curve will converge to the accurate result. FIG. 8b shows the core temperature error distribution along the line segment AB. The maximum core temperature errors are 5.9° C., 0.6° C., and 0.4° C., corresponding to the segmentation schemes (Nₓ=5, N_{y1}=2, and N_{y2}=2), (Nₓ=5, N_{y1}=3, and N_{y2}=4), and (Nₓ=5, N_{y1}=3, and N_{y2}=5), respectively. In this analysis, taking into account both accuracy and solution time, the segmentation numbers are determined as Nₓ=5, N_{y1}=3, and N_{y2}=5, respectively.

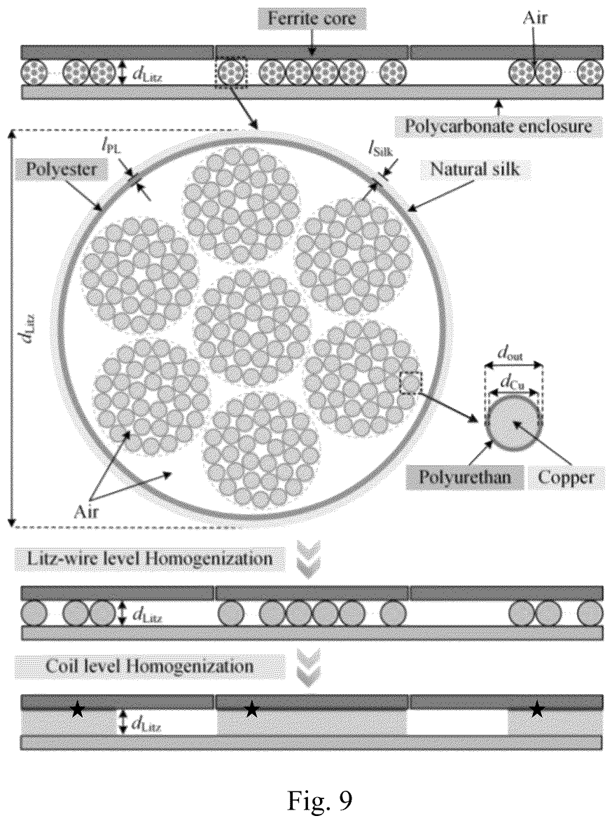

FIG. 9 shows the internal structure of the Litz wire in a coil. In the coil-level homogenized model, the dark, solid lines marked with star shapes between the core and the homogenized coil at the interface represent the contact thermal resistance. The Litz wire consists of copper, polyurethane, polyester, natural silk, and air. These materials have vastly different dimensions and physical properties, making it impossible to perform thermal analysis directly. Additionally, the small air gaps between the Litz wires, polycarbonate enclosure, and magnetic cores will introduce a significant computational burden. Therefore, it is necessary to translate the multi-scale and multi-phase domain into a homogeneous mixture with equivalent thermal parameters at the coil level [30]. Below, the calculation methods for equivalent specific heat capacity and equivalent thermal conductivity at the coil level will be discussed.

1) Equivalent specific heat capacity: The product of the equivalent specific heat capacity c_{eq} and the equivalent density ρ_{eq}, namely the equivalent heat capacity C_{eq}, can be calculated as

$$\text{?} \qquad ( 4 )$$

$$\text{?} \text{indicates text missing or illegible when filed}$$

where cₘ, ρₘ, and vₘ are the specific heat capacity, the density, and the volume ratio of the m^{th} material, respectively [30]. The equivalent density is the volume-weighted average of the densities of individual materials. According to (4), the equivalent specific heat capacity can be calculated as

$$\text{?} \qquad ( 5 )$$

$$\text{?} \text{indicates text missing or illegible when filed}$$

Based on the material properties in Table II and dimensional parameters in Table III, and in combination with equations (4) and (5), the equivalent specific heat capacity can be calculated as 360 J·kg⁻¹·K⁻¹.

TABLE II
MATERIAL PROPERTIES IN LITZ WIRE [32]-[34]

| | Thermal | Specific Heat | |
|---|---|---|---|
| | Conductivity | Capacity | Density |
| Material | (W · m⁻¹ · K⁻¹) | (J · kg⁻¹ · K⁻¹) | (kg · m⁻³) |
| Copper | 401 | 385 | 8933 |
| Polyurethan | 0.23 | 1600 | 24 |
| Polyester | 0.15 | 1170 | 1395 |
| Natural Silk | 0.043 | 1380 | 1320 |
| Air | 0.025 | 1007 | 1.204 |

TABLE III
KEY DIMENSIONAL PARAMETERS IN LITZ WIRE

| Symbol | Description | Value (mm) |
|---|---|---|
| d_{Ca} | Internal diameter of single wire | 0.10 |
| d_{Line} | External diameter of single wire | 0.116 |
| L_{PL} | Thickness of polyester | 0.05* |
| l_{Silk} | Thickness of natural silk | 0.30* |
| d_{Litz} | Integral diameter of Litz wire | 5.23 |

Note:
*represent estimated value.

2) Equivalent thermal conductivity: The Litz wire exhibits pronounced anisotropic thermal conductivity, where the longitudinal thermal conductivity is much greater than the transverse thermal conductivity. The longitudinal thermal conductivity at the coil level can be calculated as

$$\text{?} \qquad ( 6 )$$

$$\text{?} \text{indicates text missing or illegible when filed}$$

where kₘ and vₘ are the thermal conductivity and the volume ratio of the m^{th} material, respectively.

For the transverse thermal conductivity, a two-step homogenization process is required [31]. When homogenizing at the Litz wire level, the transverse thermal conductivity at the Litz wire level can be calculated as

$$\text{?} \qquad ( 7 )$$

$$\text{?} \text{indicates text missing or illegible when filed}$$

where k_{Cu} is the thermal conductivity of copper, kᵢ is the volume-weighted average thermal conductivity of the other materials inside a Litz wire, excluding copper, and τ is the volume ratio of copper.

When homogenizing at the coil level, the transverse thermal conductivity at the coil level can be calculated as

$$\text{?} \qquad ( 8 )$$

$$\text{?} \text{indicates text missing or illegible when filed}$$

where kₐ is the thermal conductivity of air, r is the ratio between the transverse thermal conductivity k_{Litz_eq}^{trans} and the thermal conductivity of air. The variable τ* is related to the ratio r, which can be calculated as

$$τ *= \frac{π}{4} + \frac{0.153 r - 0.214}{r + 60.18} + \frac{0.049 r - 0.243}{r + 19.568} \qquad ( 9 )$$

Based on the data provided in Tables II and III, and in combination with equations (6)-(9), equivalent longitudinal thermal conductivity and equivalent transverse thermal conductivity can be calculated, with values of 191 W·m⁻¹·K⁻¹, and 0.23 W·m⁻¹·K⁻¹, respectively. It should be noted that the homogenization process will introduce certain errors, and the calculated equivalent parameters need to be further validated based on experimental results.

3) Contact thermal resistance between magnetic core and homogenization coil: After homogenizing the coil, an equivalent coil model can be used to replace the actual coil with multiple materials. In the numerical model, if there are no magnetic cores as heat sources, this replacement poses no issue. However, with magnetic cores as heat sources, the homogenized coil and the cores are assumed to be in direct contact, which would result in consistent temperatures at the interfaces, contradicting experimental observations.

In reality, the contact between the coil and the core only occurs at certain surface areas, while the gaps in the uncontacted regions are often filled with air. Moreover, the thermal conductivity of the natural silk in direct contact with the core is very close to that of air. Therefore, an equivalent contact thermal resistance needs to be set at the interface between the core and the homogenized coil, as shown in FIG. 9. Compared with theoretical analysis, it is more convenient to calibrate this contact thermal resistance based on experimental measurement.

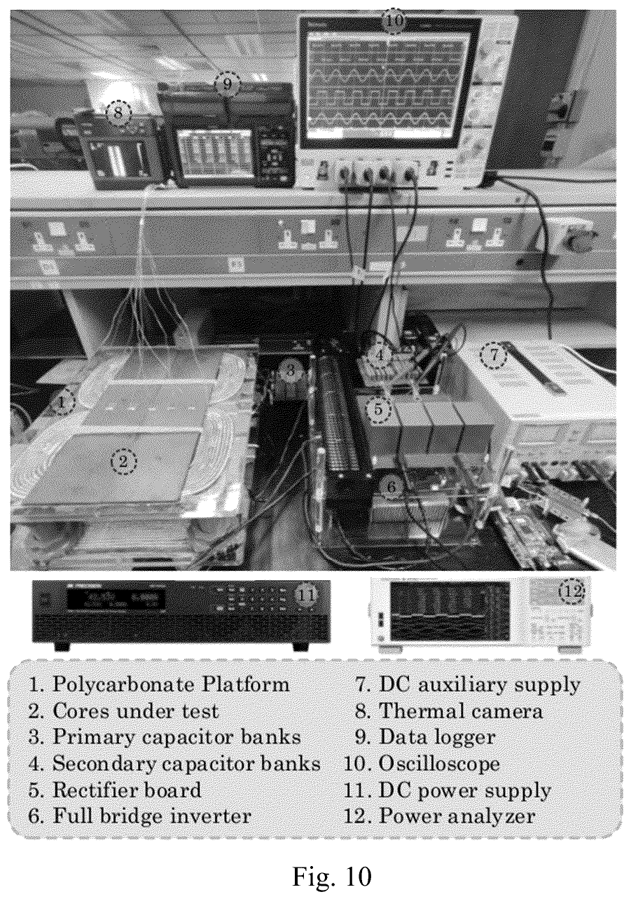

An experimental setup has been built to investigate the transient thermal characteristics of the magnetic coupler, as shown in FIG. 10. The platform features a full-bridge AC inverter using the SiC module CCB021M12FM3, a passive rectifier with the SiC Schottky diode C4D40120D, and a DC power supply from BK PRECISION MR100020. The data logger HIOKO LR8450, equipped with several K-type thermocouples, is utilized for rapid transient temperature data recording, and the thermal camera FOTRIC P5 is employed to capture thermal distribution at a steady state.

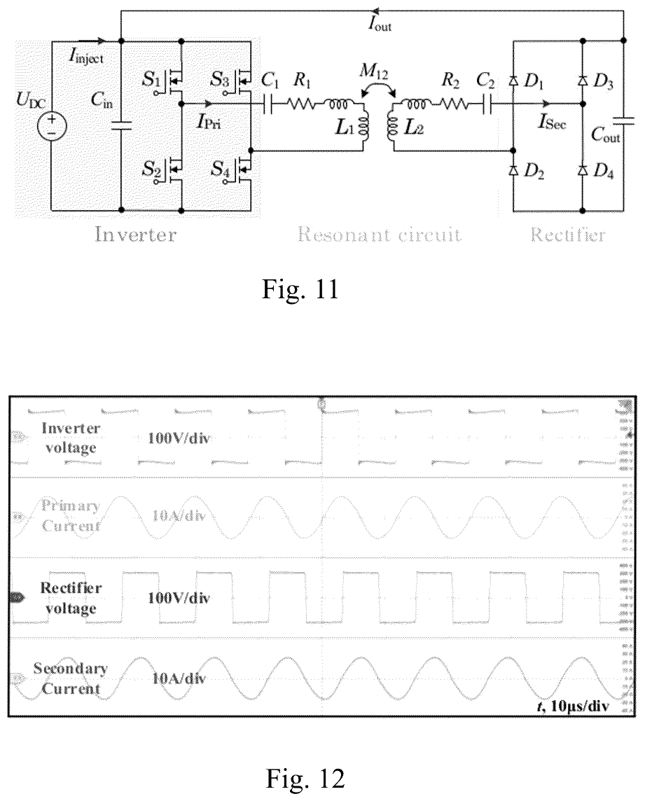

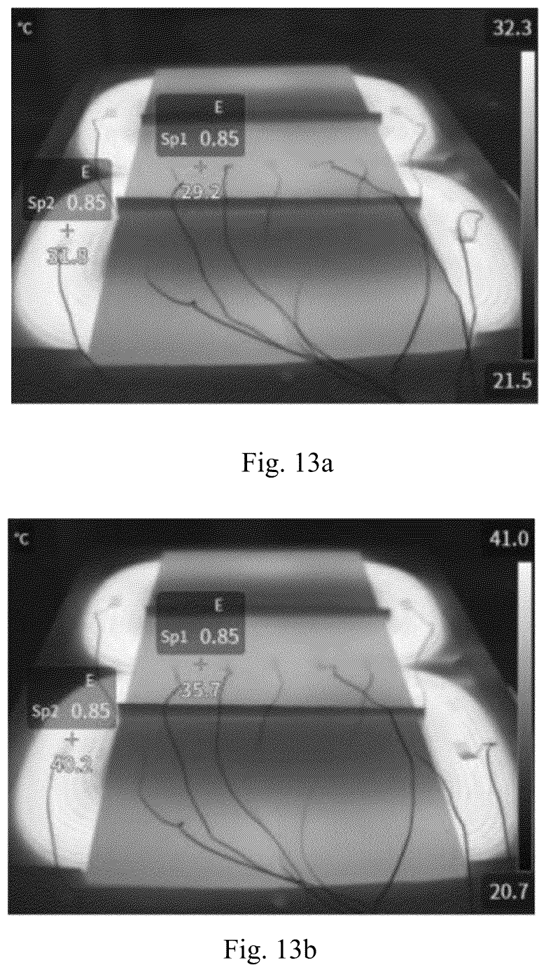

The IPT system adopts a typical series-series compensation topology. Due to the power limitations of the laboratory, a circulating current loop configuration, as shown in FIG. 11, is used to achieve high-power operation. Table IV gives key parameters in the established IPT system. Due to the parameter symmetry, the primary and secondary currents can be considered essentially identical. FIG. 12 shows the measured voltage and current waveforms when the DC-side voltage is set to U_{DC}=310 V. The RMS values of the primary current and the secondary current are I_{Pri}=19.0 A and I_{Sec}=18.5 A, respectively, with a relatively small difference of 2.5%.

TABLE IV
KEY PARAMETERS IN WPT SYSTEM

| Symbol | Description | Value | |
|---|---|---|---|
| L₁ | Primary self-inductance | 131.8 | μH |
| C₁ | Primary compensated capacitor | 26.8 | nF |
| L₂ | Secondary self-inductance | 131.4 | μH |
| C₂ | Secondary compensated capacitor | 26.8 | nF |
| M | Mutual inductance | 26.6 | μH |
| k | Coupling coefficient | 0.20 | |
| fᵣₑₛ | System resonant frequency | 85 | kHz |

FIG. 13 illustrates the measured DC-DC efficiency and AC-AC efficiency of the IPT system. It can be observed that the DC-DC efficiency increases with the output power, reaching a maximum of 95.4%. In contrast, the AC-AC efficiency decreases as the output power increases, which is primarily due to the significant increase in magnetic losses caused by the primary and secondary currents.

The temperature measurement system includes K-type thermocouples and a thermal camera. Due to imperfect contact with the thermal interface, the temperature measured by thermocouples tends to underestimate the actual temperature at the monitoring point [35]. Therefore, according to the temperature measured by the thermal camera, the transient temperature measured by the thermocouple should be corrected as

$$\text{?} \qquad ( 10 )$$

$$\text{?} \text{indicates text missing or illegible when filed}$$

where T_{IR}(∞) is the steady-state temperature recorded by the infrared thermal imager, T_{TC}(0), T_{TC}(∞), and ΔT_{TC}(t) represent the initial temperature, steady-state temperature, and temperature rise, respectively, at time t recorded by the thermocouples.

The homogenized coil model may be a major contributor to simulation errors, and it is necessary to validate the homogenization thermal parameters and determine the contact thermal resistance based on experimental data. To accomplish this, the DC heating experiments are performed on the coil, in which the core does not generate any loss.

FIGS. 13a and 13b show the thermal images of the magnetic coupler under different DC currents. When the DC currents are set to I_{DC}=21.7 A and I_{DC}=30.5 A, the steady temperature differences between the Sp1 point on the core (core_sp1) and the Sp2 point on the coil (coil_sp2) are 2.6° C. and 4.5° C., respectively.

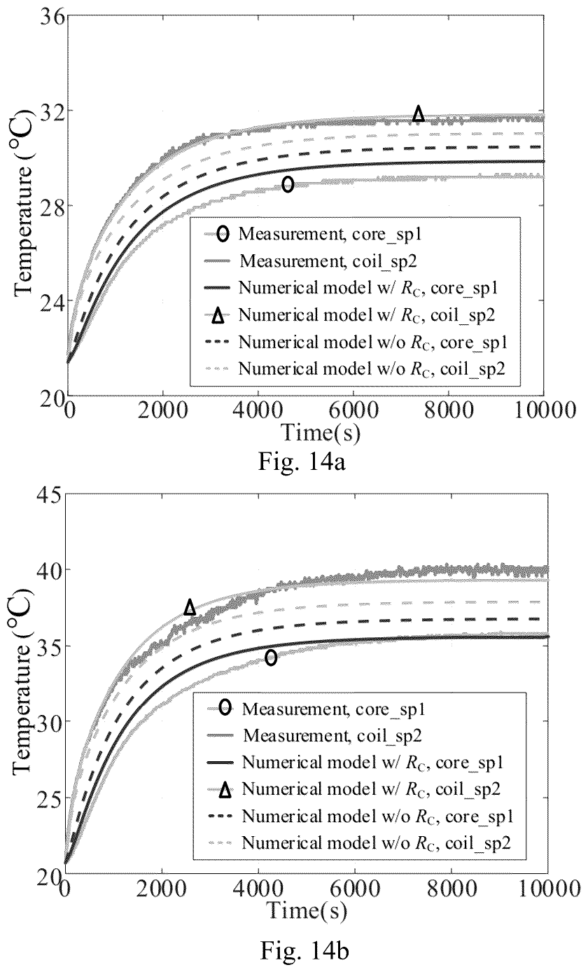

FIGS. 14a and 14b compare numerical simulations and experimental measurements under different DC currents. Without contact thermal resistance R_{C} in the simulation model, significant discrepancies arise between the simulation and experimental results. Specifically, in both transient and steady-state conditions, the simulated core temperature is consistently higher than the experimental measurement, while the simulated coil temperature is consistently lower. The simulated temperature difference of the two points, core_sp1 and coil_sp2, is significantly smaller than the measured temperature difference. Through parameter sensitivity analysis, it is found that the temperature difference is primarily related to the interface contact thermal resistance. If the contact thermal resistance R_{C} is set to a suitable value (0.0162 m²·K·W⁻¹), the simulated core and coil temperatures show improved agreement with the experimental measurements. This contact thermal resistance corresponds to an air gap of 0.42 mm between the core and the coil. This size is close to the thickness of natural silk (0.30 mm). The maximum simulation errors of the two numerical models under different DC currents can be found in Table V.

TABLE V
MAXIMUM ERRORS UNDER DIFFERENT DC CURRENT

| | Contact thermal | |
|---|---|---|
| DC Current | resistance | Maximum error (° C.) |

| (A) | (m² · K · W⁻¹) | core_Sp1 | coil_Sp2 |
|---|---|---|---|
| 21.7 | 0 | 1.3 | 1.1 |
| | 0.0162 | 0.6 | 0.4 |
| 30.5 | 0 | 2.5 | 2.6 |
| | 0.0162 | 1.3 | 1.4 |

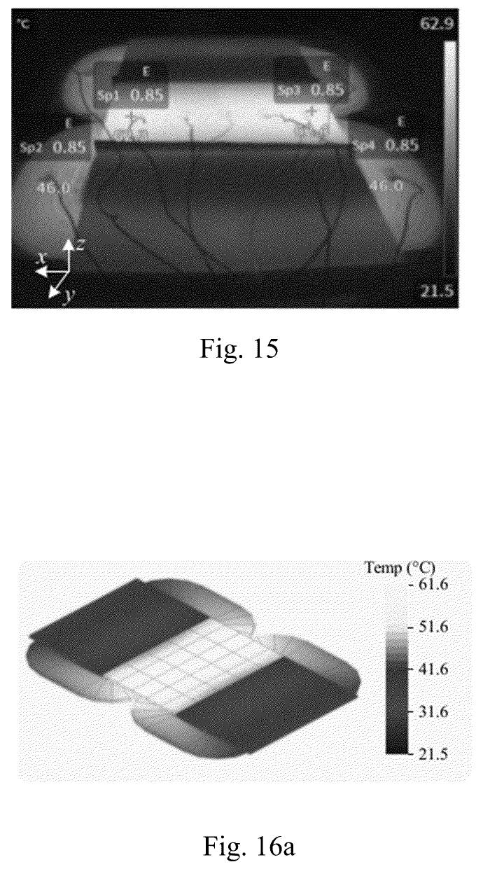

Next, the model verification under AC operating conditions will be discussed. Firstly, the DC voltage of the IPT system is set to U_{DC}=310 V. The RMS values of the primary current and the secondary current are I_{Pri}=19.0 A and I_{Sec}=18.5 A, respectively. The input and output power are 5.4 kW and 5.2 kW, respectively. FIG. 15 shows the thermal image of the magnetic coupler in such an operating condition. Overall, the temperature distribution exhibits good left-right symmetry. Along the y-axis direction, the temperature variation of the magnetic cores is significant, with the middle-positioned cores (Core_3 and Core_4) having a much higher temperature than the cores at the two sides (Core_1, Core_2, Core_5, and Core_6). Due to the heating effect of the cores, the coil temperature near the middle-positioned cores is also significantly higher than the coil temperature at other positions.

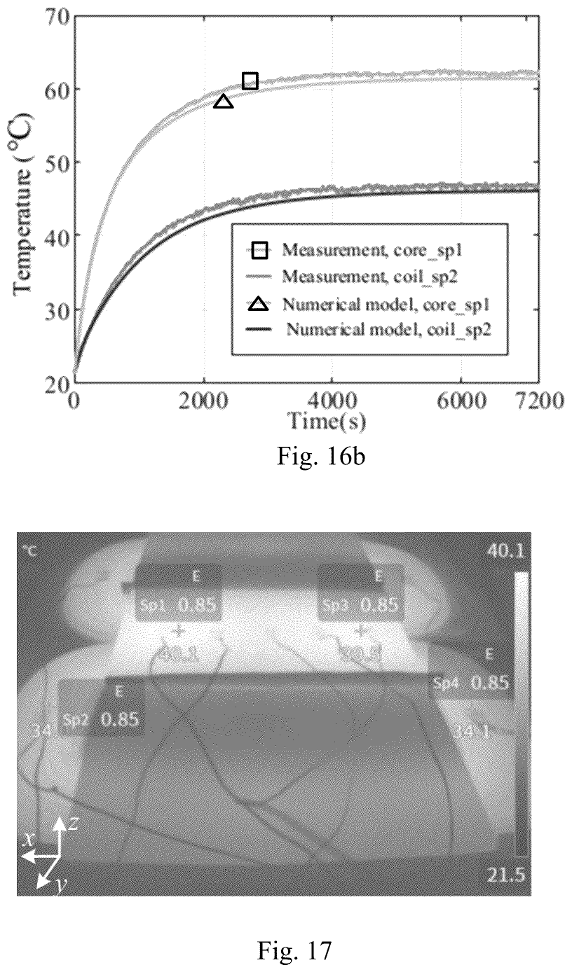

FIG. 16a shows the steady-state temperature distribution contour map, where the initial total loss of the core and the coil are set to P_{Core}=33.5 W and P_{Coil}=26.5 W, respectively. The power losses are set to be temperature-dependent, and the ambient temperature is set to 21.5° C. FIG. 16b compares the temperatures at the point Sp1 on the core (core_Sp1) and the point Sp2 on the coil (coil_Sp2) obtained from numerical model simulation and experimental measurement when U_{DC}=310 V. After the IPT system has been operating for 6000 seconds, the magnetic core and coil can be considered to have reached thermal equilibrium. The simulated temperatures show good agreement with the measured temperatures, with maximum simulation errors of 1.4° C. and 1.6° C. for core_Sp1 and coil_Sp2, respectively.

As discussed above, the thermal behavior within the magnetic coupler exhibits extremely strong nonlinearity. To further validate the accuracy of the numerical model, the DC-side voltage is set to U_{DC}=200 V. The RMS values of the primary current and the secondary current are I_{Pri}=12.7 A and I_{Sec}=12.1 A, respectively. The input and output power are 2.3 kW and 2.2 kW, respectively. FIG. 17 shows the thermal image of the magnetic coupler with thermal detection when U_{DC}=200 V. Apart from the temperature differences, the thermal distribution characteristics of the magnetic coupler are essentially consistent with those when U_{DC}=310 V.

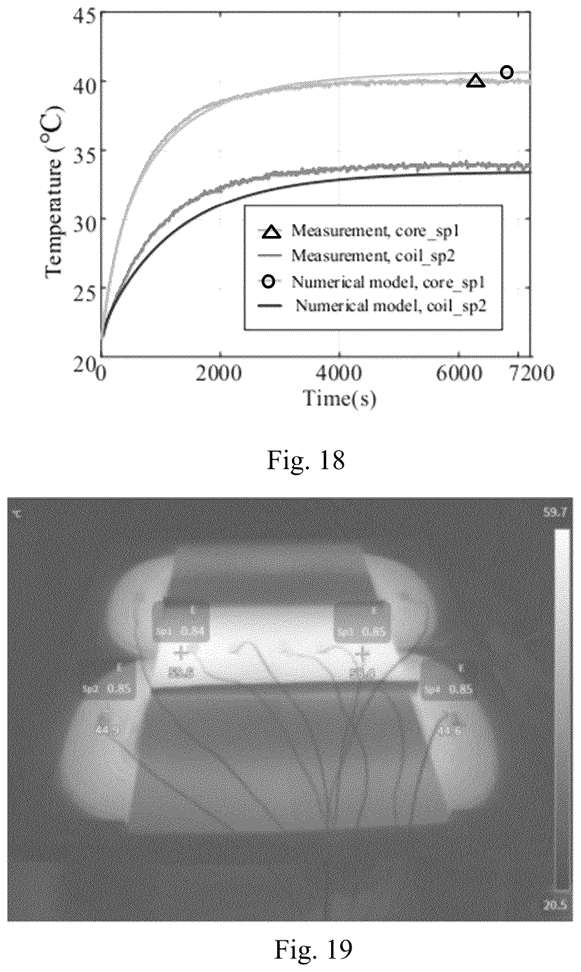

FIG. 18 compares the temperatures from numerical simulation and experimental measurement when U_{DC}=200 V. In the numerical simulation, the initial total losses of the core and the coil are set to P_{Core}=12.8 W and P_{Coil}=11.8 W, respectively, and the ambient temperature is set to 21.5° C. It can be observed that the simulated temperatures closely match the measured values, with errors of up to 1.0° C. for core_Sp1 and 1.3° C. for coil_Sp2, which well verified the proposed numerical simulation model.

The accuracy of the numerical simulation model has also been verified under the coil misalignment condition. In an experimental setup with the measurement system, the coil is misaligned by 90 mm in the x-direction and 60 mm in the y-direction. The self-inductance of the IPT system remains essentially unchanged, but the coupling coefficient decreases from 0.20 to 0.13. The RMS values of the primary current and the secondary current are I_{Pri}=19.6 A and I_{Sec}=18.2 A, respectively. FIG. 19 shows the thermal image with thermal spot detection when U_{DC}=185V with misalignment. Despite the effect of misalignment, the overall temperature distribution still exhibits good left-right symmetry.

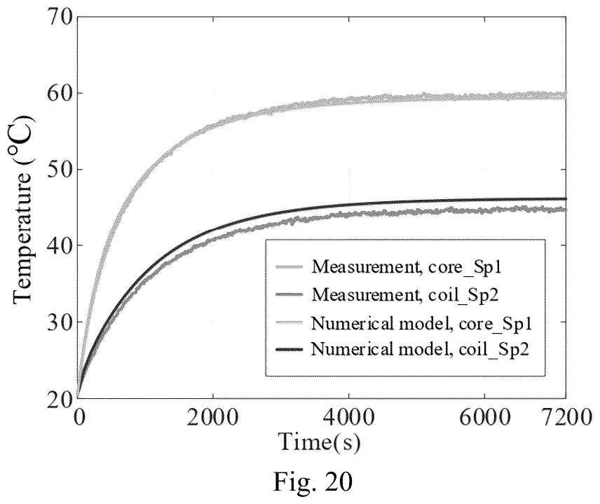

FIG. 20 compares the numerical simulation and experimental measurement. In the numerical simulation, the initial total losses of the core and the coil are set to P_{Core}=28.9 W and P_{Coil}=28.6 W, respectively, and the ambient temperature is set to 20.5° C. The numerical model predicts temperatures with maximum errors of 1.0° C. for the core_Sp1 and 1.7° C. for the coil_Sp2, further proving the credibility of the numerical simulation model.

TABLE VI
MAXIMUM ERRORS WITH AND WITHOUT LOSS CALIBRATION

| | Maximum errors | | Maximum errors | |
|---|---|---|---|---|
| | with calibration (° C.) | | without calibration (° C.) | |
| Test condition | core_Sp1 | coil_Sp2 | core_Sp1 | coil_Sp2 |
| U_{DC} = 310 V without misalignment | 1.4 | 1.6 | 3.1 | 2.1 |
| U_{DC} = 200 V without misalignment | 1.0 | 1.3 | 1.2 | 1.6 |
| U_{DC} = 185 V with misalignment | 1.0 | 1.7 | 2.8 | 1.1 |
| (X = 90 mm, Y = 60 mm) | | | | |

Due to the high complexity of thermal analysis, model parameter calibration is a critical step in achieving high-value and high-accuracy simulations. Currently, numerous studies focus on model calibration [36], and some commercial software, such as ANSYS and COMSOL, have the capability for model calibration. In this work, the core loss parameters (kf^{α} and β) are carefully calibrated through experiments to improve simulation accuracy. It should be noted that the difference between the calibrated and measured core loss is minimal. Even without calibration, the numerical model still achieves good accuracy. Table VI summarizes the maximum simulation errors with and without loss calibration under different test conditions. The maximum simulation errors with and without calibration are 1.6° C. and 3.1° C., respectively. Considering the high nonlinearity and complexity of thermal analysis, as well as the measurement error (±3° C.), these results are entirely acceptable.

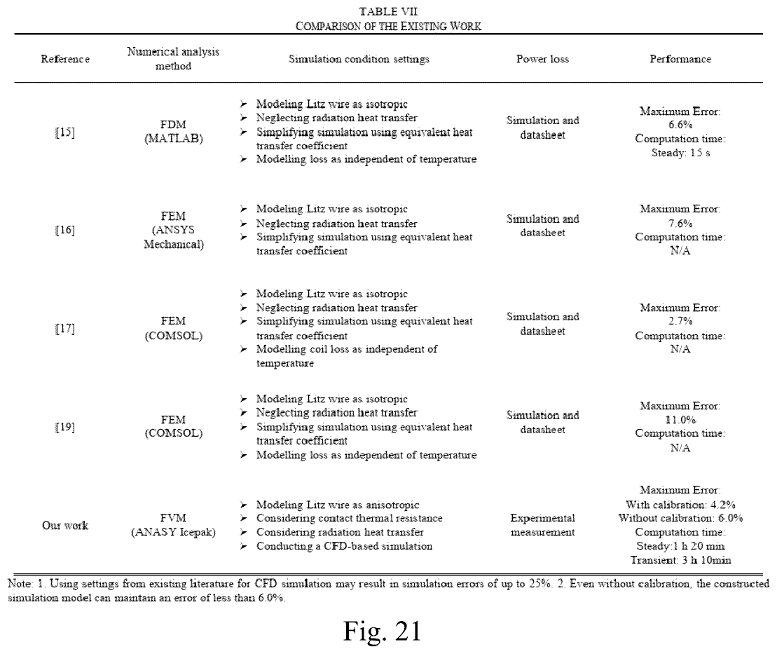

Table VII in FIG. 21 compares typical numerical thermal analysis methods, including the FEM, FVM, and FDM. Compared to previous studies, this work thoroughly incorporates a range of detailed factors that influence model accuracy during the modeling process. Consequently, the proposed thermal analysis method demonstrates significantly improved predictive accuracy, achieving errors of only 4.2% with calibration and 6.0% without calibration. By contrast, CFD simulations using parameter settings from existing literature produce errors as high as 25%.

One can see, therefore, that exemplary embodiments of the invention provide a comprehensive transient thermal analysis for the IPT double-D magnetic coupler. An automated interactive tool has been developed to improve the efficiency of model construction and transient thermal analysis. The CFD-based numerical model fully takes into account critical factors that impact accuracy during the modeling process, such as the thermal anisotropy of the coil, contact thermal resistance at the core-coil interface, radiation effects, etc. Experimental results show that the numerical model can simulate the dynamic temperature changes of the magnetic coupler with an error of 4.2% after calibration and 6.0% without calibration. The numerical model and power loss measurement methods presented in this work enable electrical engineers to perform preliminary thermal evaluation and optimization of the IPT system.

The proposed thermal modeling method can be used to evaluate the transient thermal behavior of the magnetic coupler in the IPT system. The main functions of the proposed thermal modeling method include:
(1) Simulate the transient thermal behavior of the coil and core in the magnetic coupler with relatively high accuracy. Based on the proposed thermal modeling method, the constructed thermal model comprehensively considers the thermal conductivity anisotropy of the coil and radiation heat dissipation, and does not use equivalent heat transfer coefficients to simplify the simulation.
(2) Reduce the time required for transient thermal simulation. Based on the proposed thermal modeling method, both the coil loss and core loss are set as temperature-dependent, avoiding electromagnetic-thermal two-way coupling simulation.

In practical applications, the increase in power density, combined with a compact structure, poses a strong thermal challenge to the reliable operation of the IPT system. For widely used Mn—Zn ferrites in the magnetic coupler, their performance is known to be highly sensitive to temperature. Once the operating temperature of the ferrite core exceeds a critical temperature, the core loss will increase with temperature. Without timely intervention, the core in the magnetic coupler will experience catastrophic thermal runaway. Therefore, for safe and reliable operation, more attention needs to be paid to evaluating the IPT system's thermal performance, with a particular focus on the hotspots of the core in the magnetic coupler. The proposed thermal modeling method enables electrical engineers to conduct thermal evaluation and optimization in the early design stage of the high-power IPT systems, such as those used in electric vehicles.

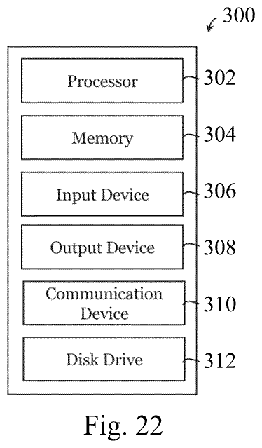

Various method embodiments of the invention may be implemented using system implemented with hardware and/or software. For example, FIG. 22 shows a data processing system 300 in some embodiments of the invention. The data processing system 300 may be used to conduct the rotatable antenna array optimizing task as described above, and more generally, the data processing system 300 may be used to perform or to facilitate performing of one or more method embodiments of the invention.

The data processing system 300 generally comprises suitable components necessary to receive, store, and execute appropriate computer instructions, data, commands, and/or codes. The main components of the data processing system 300 are a processor 302 and a memory (storage) 304. The processor 302 may include one or more: CPU(s), MCU(s), GPU(s), logic circuit(s), Raspberry Pi chip(s), digital signal processor(s) (DSP), application-specific integrated circuit(s) (ASIC), field-programmable gate array(s) (FPGA), or any other digital or analog circuitry/circuitries configured to interpret and/or to execute program instructions and/or to process signals and/or information and/or data. The memory 304 may include one or more volatile memory (such as RAM, DRAM, SRAM, etc.), one or more non-volatile memory (such as ROM, PROM, EPROM, EEPROM, FRAM, MRAM, FLASH, SSD, NAND, NVDIMM, etc.), or any of their combinations. Appropriate computer instructions, commands, codes, information and/or data may be stored in the memory 304. Computer instructions for executing or facilitating executing the method embodiments of the invention may be stored in the memory 304. The processor 302 and memory (storage) 304 may be integrated or separated (and operably connected).

Optionally, the data processing system 300 further includes one or more input devices 306. Example of such input device 306 include: keyboard, mouse, stylus, image scanner, microphone, tactile/touch input device (e.g., touch sensitive screen), image/video input device (e.g., camera), etc. The input device 306 may be used to receive user input. Optionally, the data processing system 300 further includes one or more output devices 308. Example of such output device 308 include: display (e.g., monitor, screen, projector, etc.), speaker, headphone, earphone, printer, additive manufacturing machine (e.g., 3D printer), etc. The display may include an LCD display, a LED/OLED display, or other suitable display, which may or may not be touch sensitive. The output device 308, e.g., the display, may be used to display the 3D medical image, images of the original slices, images of the reconstructed slices, images of the residual slices, etc. The data processing system 300 may further include one or more disk drives 312 which may include one or more of: solid state drive, hard disk drive, optical drive, flash drive, magnetic tape drive, etc. A suitable operating system may be installed in the data processing system 300, e.g., on the disk drive 312 or in the memory 304. The memory 304 and the disk drive 312 may be operated by the processor 302. Optionally, the data processing system 300 also includes a communication device 310 for establishing one or more communication links (not shown) with one or more other computing devices, such as servers, personal computers, terminals, tablets, phones, watches, IoT devices, or other wireless computing devices. The communication device 310 may include one or more of: a modem, a Network Interface Card (NIC), an integrated network interface, an NFC transceiver, a ZigBee transceiver, a Wi-Fi transceiver, a Bluetooth® transceiver, a radio frequency transceiver, a cellular (2G, 3G, 4G, 5G, above 5G, etc.) transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 302, the memory 304 (optionally the input device(s) 306, the output device(s) 308, the communication device(s) 310 and the disk drive(s) 312, if present) are connected with each other, directly or indirectly, through a bus, a Peripheral Component Interconnect (PCI), such as PCI Express, a Universal Serial Bus (USB), an optical bus, or other like bus structure. In one embodiment, at least some of these components may be connected wirelessly, e.g., through a network, such as the Internet or a cloud computing network.

A person skilled in the art would appreciate that the data processing system 300 in FIG. 4 is merely an example and that the data processing system 300 can, in other embodiments, have different configurations (e.g., include additional components, has fewer components, etc.).

Although not required, one or more embodiments described with reference to the Figures can be implemented as an application programming interface (API) or as a series of libraries for use by a developer or can be included within another software application, such as a terminal or computer operating system or a portable computing device operating system. In one or more embodiments, as program modules include routines, programs, objects, components, and data files that assist in the performance of particular functions, the skilled person will understand that the functionality of the software application may be distributed across a number of routines, objects, and/or components to achieve the same functionality desired herein.

The exemplary embodiments are thus fully described. Although the description referred to particular embodiments, it will be clear to one skilled in the art that the invention may be practiced with variation of these specific details. Hence, this invention should not be construed as limited to the embodiments set forth herein.

While the embodiments have been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

What is claimed is:

1. A computer-implemented thermal modeling method for a magnetic coupler used in an inductive power transfer system, the method comprising:
a) providing a core model of a magnetic core of the magnetic coupler;
b) dividing the core model into a plurality of core blocks to obtain a divided core;
c) providing a coil model of a coil of the magnetic coupler;
d) homogenizing the coil model to obtain a homogenized coil; and
e) setting an equivalent contact thermal resistance at an interface between the divided core and the homogenized coil.

2. The computer-implemented thermal modeling method of claim 1, wherein Step a) further comprises:
f) simulating magnetic flux density in the magnetic core; and
g) converting amplitude of the magnetic flux density into temperature-dependent losses.

3. The computer-implemented thermal modeling method of claim 2, wherein Step b) further comprises:
h) constructing a geometric model of the magnetic core;
i) geometrically segmenting the geometric model into the plurality of core blocks; and
j) mapping the temperature-dependent losses to respective ones of the plurality of core blocks.

4. The computer-implemented thermal modeling method of claim 3, wherein in Step g) the converting into the temperature-dependent losses is by region.

5. The computer-implemented thermal modeling method of claim 1, wherein the coil model is homogenized at a first coil level and a second coil level.

6. The computer-implemented thermal modeling method of claim 5, wherein the first coil level is a Litz wire level.

7. The computer-implemented thermal modeling method of claim 5, wherein the second coil level is a coupler coil level.

8. The computer-implemented thermal modeling method of claim 1, wherein Step d) further comprises a step of dividing the coil model into a plurality of coil blocks.

9. The computer-implemented thermal modeling method of claim 1, wherein Step b) further comprises the step of determining the minimum number of core divisions and applying a core loss to each of the core blocks.

10. The computer-implemented thermal modeling method of claim 1, further comprises a step of determining the value of contact thermal resistance by DC heating experiments.

11. A non-transitory computer-readable medium, having stored thereon program instructions that, upon execution by a computing device, cause the computing device to perform the method according to claim 1.

12. A computing system comprising:
a) one or more processors; and
b) memory containing instructions that, when executed by the one or more processors, cause the computing system to perform the method according to claim 1.
